(19) United States
(12) Patent Application Publication
(10) Pub. No.: US 2003/0099198 A1
(43) Pub. Date: May 29, 2003

(54) Multicast service delivery in a hierarchical network

(75) Inventors: Frederick Kiremidjian, Danville, CA (US); Li-Ho Raymond Hou, Saratoga, CA (US)

Correspondence Address: LAW OFFICES OF THOMAS E. SCHATZEL, A Professional Corporation, Suite 240, 16400 Lark Avenue, Los Gatos, CA, 95032-2547, US

(73) Assignee: AMPLIFY.NET, INC.

(21) Appl. No.: 10/004,079

(22) Filed: Nov. 27, 2001

(51) Int. Cl. H04L 12/56

(52) U.S. Cl. 370/230.1; 370/390; 370/412

(57) ABSTRACT

A multicast method generates a packet-tracking queue with individual entries representing datapackets for transfer through a hierarchical network. The actual datapacket and its real payload are stored as one item in a FIFO buffer. Any packet-tracking queue entry representing a multicast datapacket is expanded into several consecutive entries, one each for the individual subscribers enrolled to receive a broadcast. A first of such expanded entries is flagged as being first, and a last such expanded entry is flagged as being last. Each expanded entry may be subject to its own unique service-level policy, with the result that the datapackets can be released and cleared in any order. If the first or last are released, then the next are marked as first or last. When only one expanded entry is left, it will be flagged as being both first and last. When it is released, the entry in the packet-tracking queue is cleared as well as the actual datapacket and its real payload in the FIFO buffer. Such individually delayed releases of the multicast datapackets help enforce the bandwidth limiting function of the service-level policies involved.

### BACKGROUND OF THE INVENTION

1. Field of the Invention

The invention relates generally to computer network protocols and equipment for adjusting packet-by-packet bandwidth according to the source and/or destination IP-addresses of each such packet. More specifically, the present invention relates to methods and semiconductor devices for replicating multicast datapackets when using a packet-tracking queue.

2. Description of the Prior Art

Access bandwidth is important to Internet users. New cable, digital subscriber line (DSL), and wireless “always-on” broadband-access together are expected to eclipse dial-up Internet access in 2001. So network equipment vendors are scrambling to bring a new generation of broadband access solutions to market for their service-provider customers. These new systems support multiple high speed data, voice and streaming video Internet-protocol (IP) services, and not just over one access media, but over any media.

Flat-rate access fees for broadband connections will shortly disappear, as more subscribers with better equipment are able to really use all that bandwidth and the systems' overall bandwidth limits are reached. One of the major attractions of broadband technologies is that they offer a large Internet access pipe that enables a huge amount of information to be transmitted. Cable and fixed point wireless technologies have two important characteristics in common. Both are “fat pipes” that are not readily expandable, and they are designed to be shared by many subscribers.

Although DSL allocates a dedicated line to each subscriber, the bandwidth becomes “shared” at a system aggregation point. In other words, while the bandwidth pipe for all three technologies is “broad,” it is always “shared” at some point and the total bandwidth is not unlimited. All broadband pipes must therefore be carefully and efficiently managed.

Internet Protocol (IP) datapackets are conventionally treated as equals, and therein lies one of the major reasons for its “log jams”. When all IP-packets have equal right-of-way over the Internet, a “first come, first serve” service arrangement results. The overall response time and quality of delivery service is promised to be on a “best effort” basis only. Unfortunately all IP-packets are not equal, certain classes of IP-packets must be processed differently.

In the past, such traffic congestion has caused no fatal problems, only an increasing frustration from the unpredictable and sometimes gross delays. However, new applications use the Internet to send voice and streaming video IP-packets that mix-in with the data IP-packets. These new applications cannot tolerate a classless, best efforts delivery scheme, and include IP-telephony, pay-per-view movie delivery, radio broadcasts, cable modem (CM), and cable modem termination system over two-way transmission hybrid fiber/coax cable.

Internet service providers (ISPs) need to be able to automatically and dynamically integrate service subscription orders and changes, e.g., for “on demand” services. Different classes of services must be offered at different price points and quality levels. Each subscriber's actual usage must be tracked so that their monthly bills can accurately track the service levels delivered. Each subscriber should be able to dynamically order any service based on time of day/week, or premier services that support merged data, voice and video over any access broadband media, and integrate them into a single point of contact for the subscriber.

There is an urgent demand from service providers for network equipment vendors to provide integrated broadband-access solutions that are reliable, scalable, and easy to use. These service providers also need to be able to manage and maintain ever growing numbers of subscribers.

Conventional IP-addresses, as used by the Internet, rely on four-byte hexadecimal numbers, e.g., 00H-FFH. These are typically expressed with four sets of decimal numbers that range 0-255 each, e.g., “192.55.0.1”. A single look-up table could be constructed for each of 4,294,967,296 (256⁴) possible IP-addresses to find what bandwidth policy should attach to a particular datapacket passing through. But with only one byte to record the policy for each IP-address, that approach would require more than four gigabytes of memory. So this is impractical.

There is also a very limited time available for the bandwidth classification system to classify a datapacket before the next datapacket arrives. The search routine to find which policy attaches to a particular IP-address must be finished within a finite time. And as the bandwidths get higher and higher, these search times get proportionally shorter.

Hierarchical networks, as used in cable-modem Internet service provider (ISP) systems, must be able to support multicast broadcasts without undue loading and congestion. A single incoming multicast datastream is typically duplicated by the local router and delivered to the local subscribers. When each subscriber is being rationed bandwidth according to a service-level agreement policy, the bandwidth controls must be able to manage real datapacket delivery that consumes real bandwidth. But at the same time, the higher levels in the hierarchical network are passing mostly virtual traffic with multiple simultaneous destination IP-addresses.

### SUMMARY OF THE PRESENT INVENTION

It is therefore an object of the present invention to provide a method for replicating multicast datastreams while controlling individual network-node bandwidths according to service-level policies.

It is another object of the present invention to provide a multicast mechanism for delivery of replicated multicast datapackets independently released by independent service-level policies attached to each subscriber.

It is a further object of the present invention to provide a method for allocating network bandwidth-allocation credits after each scan of a packet-tracking queue with dynamic size.

Briefly, a multicast method embodiment of the present invention generates a packet-tracking queue with individual entries representing datapackets for transfer through a hierarchical network. The actual datapacket and its real payload are stored as one item in a FIFO buffer. Any packet-tracking queue entry representing a multicast datapacket is expanded into several consecutive entries, one each for the individual subscribers enrolled to receive a multicast. A first of such expanded entries is flagged as being first, and a last such expanded entry is flagged as being last. Each expanded entry may be subject to its own unique service-level policy, with the result that the datapackets can be released and cleared in any order. If the first or last are released, then the next or the previous are marked as first or last. When only one expanded entry is left, it will be flagged as being both first and last. When it is released, the entry in the packet-tracking queue is cleared as well as the actual datapacket and its real payload in the FIFO buffer. Such individually delayed releases of the multicast datapackets help enforce the bandwidth limiting function of the service-level policies involved.

An advantage of the present invention is a multicast traffic device and method are provided for allocating bandwidth to network nodes according to a service-level policy.

A still further advantage of the present invention is a semiconductor intellectual property is provided that prioritizes multicast datapacket transfers according to individual service-level agreement policies in real time and at high datapacket rates.

These and many other objects and advantages of the present invention will no doubt become obvious to those of ordinary skill in the art after having read the following detailed description of the preferred embodiments which are illustrated in the drawing figures.

### IN THE DRAWINGS

FIG. 1 is a schematic diagram of a hierarchical network embodiment of the present invention with a gateway to the Internet;

FIG. 2A is a diagram of a single queue embodiment of the present invention for checking and enforcing bandwidth service level policy management in a hierarchical network;

FIG. 2B is a diagram showing how the credit checking and credit decrementing flags can be arranged to help manage the single queue;

FIG. 3 is a functional block diagram of a system of interconnected semiconductor chip components that include a replicator, a traffic-shaping cell and a classifier, and that implements various parts of FIGS. 1 and 2; and

FIGS. 4A-4D are diagrams of expanded portions of the packet-tracking queue of FIG. 2, showing how individual expanded entries can be cleared in random order and new ones can take the role as being first and/or last as indicated by respective flags.

### DETAILED DESCRIPTION OF THE PREFERRED EMBODIMENTS

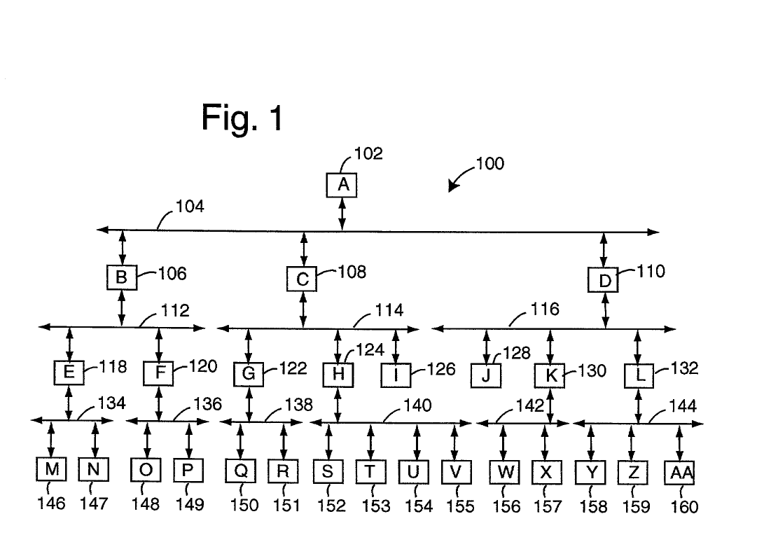

FIG. 1 represents a hierarchical network embodiment of the present invention, and is referred to herein by the general reference numeral 100. The network 100 has a hierarchy that is common in cable network systems. Each higher level node and each higher level network is capable of data bandwidths much greater than those below it. But if all lower level nodes and networks were running at maximum bandwidth, their aggregate bandwidth demands would exceed the higher level's capabilities.

The network 100 therefore includes bandwidth management that limits the bandwidth made available to daughter nodes, e.g., according to a paid service-level policy. Higher bandwidth policies are charged higher access rates. Even so, when the demands on all the parts of a branch exceed the policy for the whole branch, the lower-level demands are trimmed back. For example, to keep one branch from dominating trunk-bandwidth to the chagrin of its peer branches.

The present Assignee, Amplify.net, Inc., has filed several United States Patent Applications that describe such service-level policies and the mechanisms to implement them. Such include INTERNET USER-BANDWIDTH MANAGEMENT AND CONTROL TOOL, now U.S. Pat. No. 6,085,241, issued Mar. 14, 2000; BANDWIDTH SCALING DEVICE, Ser. No. 08/995,091, filed Dec. 19, 1997; BANDWIDTH ASSIGNMENT HIERARCHY BASED ON BOTTOM-UP DEMANDS, Ser. No. 09/718,296, filed Nov. 21, 2000; NETWORK-BANDWIDTH ALLOCATION WITH CONFLICT RESOLUTION FOR OVERRIDE, RANK, AND SPECIAL APPLICATION SUPPORT, Ser. No. 09/716,082, filed Nov. 16, 2000; GRAPHICAL USER INTERFACE FOR DYNAMIC VIEWING OF DATAPACKET EXCHANGES OVER COMPUTER NETWORKS, Ser. No. 09/729,733, filed Dec. 14, 2000; ALLOCATION OF NETWORK BANDWIDTH ACCORDING TO NETWORK APPLICATION, Ser. No. 09/718,297, filed Nov. 21, 2001; METHOD FOR ASCERTAINING NETWORK BANDWIDTH ALLOCATION POLICY ASSOCIATED WITH APPLICATION PORT NUMBERS, (Docket SS-709-07) Ser. No. 09/xxx,xxx, filed Sep. 2, 2001; and METHOD FOR ASCERTAINING NETWORK BANDWIDTH ALLOCATION POLICY ASSOCIATED WITH NETWORK ADDRESS, (Docket SS-709-08) Ser. No. 09/xxx,xxx, filed Sep. 7, 2001. All of which are incorporated herein by reference.

Suppose the network 100 represents a city-wide cable network distribution system. A top trunk 102 provides a broadband gateway to the Internet and it services a top main trunk 104, e.g., having a maximum bandwidth of 100-Mbps. At the next lower level, a set of cable modem termination systems (cable modem termination system) 106, 108, and 110, each classifies traffic into data, voice and video 112, 114, and 116. If each of these had bandwidths of 45-Mbps, then all three running at maximum would need 135-Mbps at top main trunk 104 and top gateway 102. A policy-enforcement mechanism is included that limits, e.g., each cable modem termination system 106, 108, and 110 to 45-Mbps and the top Internet trunk 102 to 100-Mbps. If all traffic passes through the top Internet trunk 102, such policy-enforcement mechanism can be implemented there alone.

Each cable modem termination system supports multiple radio frequency (RF) channels 118, 120, 122, 124, 126, 128, 130, and 132, which are limited to a still lower bandwidth, e.g., 38-Mbps each. A group of neighborhood networks 134, 136, 138, 140, 142, and 144, distribute bandwidth to end users 146-160, e.g., individual cable network subscribers residing along neighborhood streets. Each of these could buy 5-Mbps bandwidth service level policies, for example.

The integration of class-based queues and datapacket classification mechanisms in semiconductor chips necessitates more efficient implementations, especially where bandwidths are exceedingly high and the time to classify and policy-check each datapacket is exceedingly short. Therefore, embodiments of the present invention describes a new approach which manages every datapacket in the whole network 100 from a single queue. Rather, as in previous embodiments, than maintaining queues for each node A-Z, and AA, and checking each higher-level queue in sequence to see if a datapacket should be held or forwarded. Although this example describes a topology of four levels of aggregation hierarchy, six levels have been implemented and there is no limit to the number of levels.

Each entry in the single queue includes fields for the pointer to the present source or destination node (user node), and all higher level nodes (parent nodes). The bandwidth limit of every node pointed to by this entry is tested in one clock cycle in parallel to see if enough credit exists at each node level to pass the datapacket along.

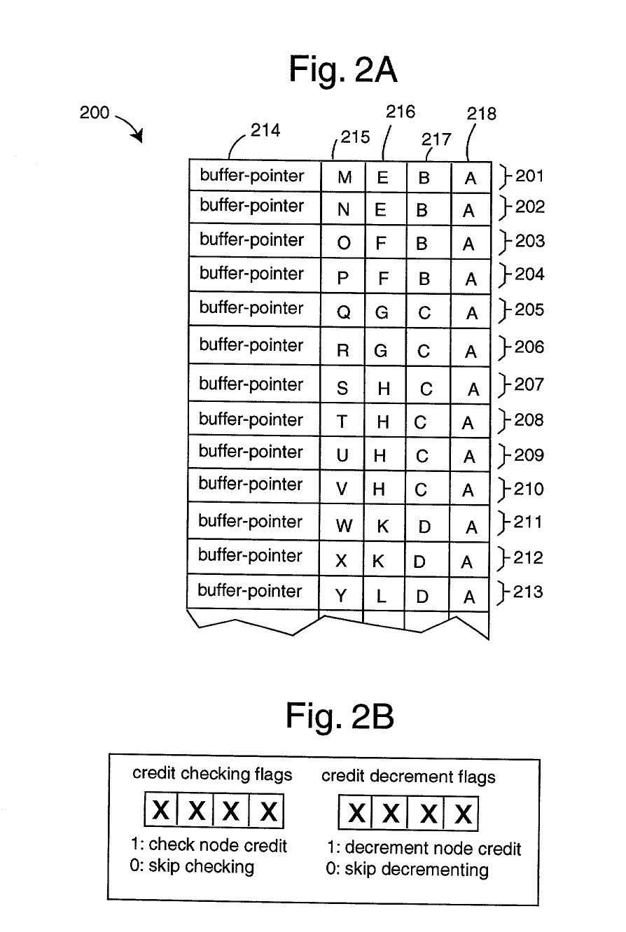

FIG. 2A illustrates a single queue 200 and several entries 201-213. A first entry 201 is associated with a datapacket sourced from or destined for subscriber node (M) 146. If such datapacket needs to climb the hierarchy of network 100 (FIG. 1) to access the Internet, the service level policies of the user node (M) 146 and parent nodes (E) 118, (B) 106 and (A) 102 will all be involved in the decision whether or not to forward the datapacket or delay it. Similarly, another entry 212 is associated with a datapacket sourced from or destined for subscriber node (X) 157. If such datapacket also needs to climb the hierarchy of network 100 (FIG. 1) to access the Internet, the service level policies of nodes (X) 157, (K) 130, (D) 110 and (A) 102 will all be involved in the decision whether or not to forward such datapacket or delay it.

There are many ways to implement the queue 200 and the fields included in each entry 201-213. The instance of FIG. 2 is merely exemplary. A buffer-pointer field 214 points to where the actual data for the datapacket resides in a buffer memory, so that the queue 200 doesn't have to spend time and resources shuffling the whole datapacket header and payload around. A hierarchical node pointer field 215-218 is divided into four subfields that represent the four possible levels of the hierarchy for each subscriber node 146-160 or nodes 126 and 128. A datapacket-size descriptor and service level policy identification number are also useful information that can be included in each of the entries 201-213.

FIG. 2B shows how the credit checking and credit decrementing flags can be arranged to help manage the single queue.

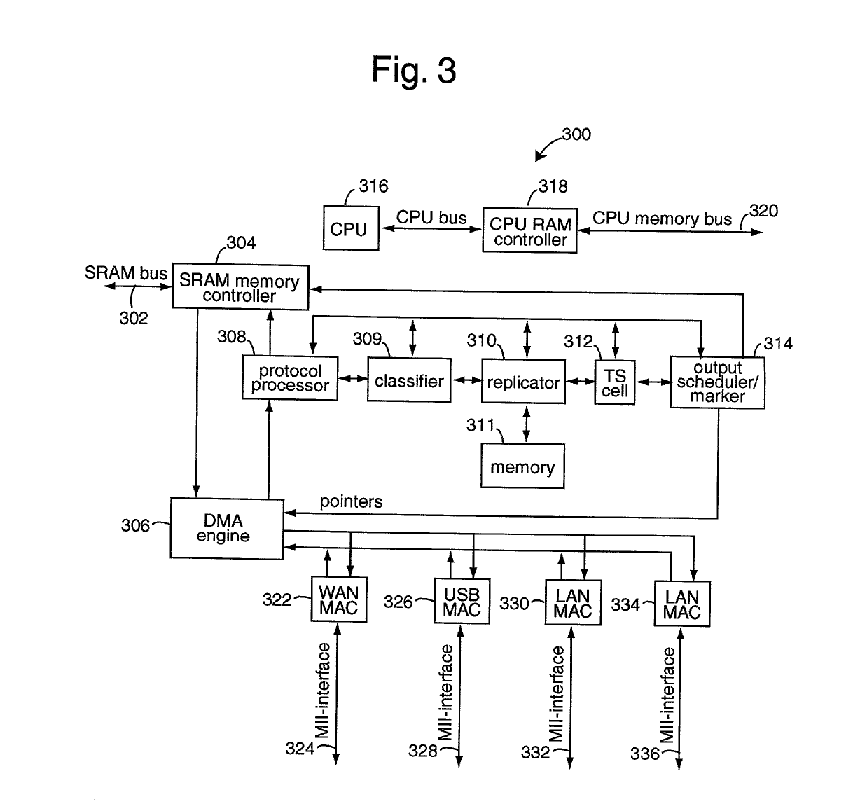

FIG. 3 represents a bandwidth management system 300 in an embodiment of the present invention. The bandwidth management system 300 is preferably implemented in semiconductor integrated circuits (IC's). The bandwidth management system 300 comprises a static random access memory (SRAM) bus 302 connected to an SRAM memory controller 304. A direct memory access (DMA) engine 306 helps move blocks of memory in and out of an external SRAM array. A protocol processor 308 parses application protocol to identify the dynamically assigned TCP/UDP port number then communicates datapacket header information with a datapacket classifier 310. Datapacket identification and pointers to the corresponding service level agreement policy are exchanged with a traffic shaping (TS) cell 312 implemented as a single chip or synthesizable semiconductor intellectual property (SIA) core. Such datapacket identification and pointers to policy are also exchanged with an output scheduler and marker 314. A microcomputer (CPU) 316 directs the overall activity of the bandwidth management system 300, and is connected to a CPU RAM memory controller 318 and a RAM memory bus 320. External RAM memory is used for execution of programs and data for the CPU 316. The external SRAM array is used to shuffle the network datapackets through according to the appropriate service level policies.

The datapacket classifier 310 first identifies the end user service level policy (the policy associated with nodes 146-160). Every end user policy also has its corresponding policies associated with all parent nodes of this user node. The classifier passes an entry that contains a pointer to the datapacket itself that resides in the external SRAM and the pointers to all corresponding nodes for this datapacket, i.e. the user nodes and its parent node. Each node contains the service level agreement policies such as bandwidth limit (CR and MBR) and the current available credit for a datapacket to go through.

A calculation periodically deposits credits in each hierarchical node to indicate the availability of bandwidth, e.g., one hundred credits for enough bandwidth to transfer one datapacket of one hundred bytes through the respective node. When a decision is made to either forward or hold a datapacket represented by each corresponding entry 201-213, the node pointer field 214 is inspected. If all credit fields 215-218 have enough credit, then the respective datapacket is forwarded through the network 100 and the entry cleared from queue 200. The consumption of the credit is reflected in a decrement of bytes transferred from each involved node. Since the classifier 310 identifies all parent nodes of a user node, it allows the semiconductor implementation to incorporate parallel limit checking of available credit of all nodes (i.e. M, E, B, A) simultaneously in one clock cycle in the TS cell 312. This invention makes it possible for the bandwidth manager to operate at a very high data speed such as 10 Gbps.

The single queue 200 also prevents datapackets from-or-to particular nodes from being passed along out of order. The TCP/IP protocol allows and expects datapackets to arrive in random order, but network performance and reliability is best if datapacket order is preserved. UDP traffic used for voice and video will get in trouble if order is not preserved.

The service-level policies for each node are defined and input by a system administrator. Internal hardware and software are used to spool and despool datapacket streams through at the appropriate bandwidths. In business model implementations of the present invention, subscribers are charged various fees for different levels of service, e.g., better bandwidth and delivery time-slots.

A network embodiment of the present invention comprises a local group of network workstations and clients with a set of corresponding local IP-addresses. Those local devices periodically need access to a wide area network (WAN). A class-based queue (CBQ) traffic shaper is disposed between the local group and the WAN, and provides for an enforcement of a plurality of service-level agreement (service-level agreement) policies on individual connection sessions by limiting a maximum data throughput for each such connection. The class-based queue traffic shaper preferably distinguishes amongst voice-over-IP (voIP), streaming video, and datapackets. Any sessions involving a first type of datapacket can be limited to a different connection-bandwidth than another session-connection involving a second type of datapacket. The service-level agreement policies are attached to each and every local IP-address, and any connection-combinations with outside IP-addresses can be ignored.

A variety of network interfaces can be accommodated, either one type at a time, or many types in parallel. For example, a wide area network (WAN) media access controller (MAC) 322 presents a media independent interface (MII) 324, e.g., 100BaseT fast Ethernet. A universal serial bus (USB) MAC 326 presents a media independent interface (MII) 328, e.g., using a USB-2.0 core. A local area network (LAN) MAC 330 has an MII connection 332. A second LAN MAC 334 also presents an MII connection 336. Other protocol and interface types include home phoneline network alliance (HPNA) network, IEEE-802.11 wireless, etc. Datapackets are received on their respective networks, classified, and either sent along to their destination or stored in SRAM to effectuate bandwidth limits at various nodes, e.g., “traffic shaping”.

The protocol processor 308, aids in the dynamic creation of policies associated with certain traffic flows. For example, to support video conferencing, one wants to be able to create a 300-Kbit/sec policy to support such calls whenever they start up. However, according to the H.323 protocol used in video conferencing, the actual port number associated with a particular call are negotiated during the call set up phase. The protocol processor 308 monitors the call set up phase of the H.323 protocol, extracts the negotiated parameters and then passes those to the micro processor so that the appropriate policy can be created.

The protocol processor 308 is implemented as a table-driven state engine, with a range from two hundred and fifty-six concurrent sessions and sixty-four states to more than 20,000 concurrent sessions. The die size for such an IC is currently estimated at 20.00 square millimeters using 0.18 micron CMOS technology.

The classifier 309 preferably manages as many as 20,000 policies using IP-address, MAC-address, port-number, and handles classification parameters. Content addressable memory (CAM) can be used in a good design implementation. The die size for such an IC is currently estimated at 3.91 square millimeters using 0.18 micron CMOS technology.

The traffic shaping (TS) cell 312 preferably manages as many as 20,000 policies using CIR, MBR, virtual-switching, and multicast-support shaping parameters. A typical TS cell 312 controls three to six levels of network hierarchy, e.g., as in FIG. 1. A single queue is implemented to preserve datapacket order, as in FIG. 2. Such TS cell 312 is preferably self-contained with its on chip-based memory. The die size for such an IC is currently estimated at 2.00 square millimeters using 0.18 micron CMOS technology.

The traffic-shaping cell repeatedly scans the variable-depth queue to determine whether a datapacket should be forwarded through the node by checking for enough bandwidth-allocation credits, and it replenishes the bandwidth-allocation credits calculating in the variable delay caused by scanning the variable-depth queue.

The output scheduler and marker 314 schedules datapackets according to DiffServ Code Points and datapacket size. The use of a single queue is preferred. Marks are inserted according to parameters supplied by the TS cell 312, e.g., DiffServ Code Points. The die size for such an IC is currently estimated at 0.93 square millimeters using 0.18 micron CMOS technology.

The CPU 316 is preferably implemented with an ARM740T core processor with 8K of cache memory. MIPS and POWER-PC are alternative choices. Cost here is a primary driver, and the performance requirements are modest. The die size for such an IC is currently estimated at 2.50 square millimeters using 0.18 micron CMOS technology. The control firmware supports four provisioning models: TFTP/Conf_file, simple network management protocol (SNMP), web-based, and dynamic. The TFTP/Conf_file provides for batch configuration and batch-usage parameter retrieval. The SNMP provides for policy provisioning and updates. User configurations can be accommodated by web-based methods. The dynamic provisioning includes auto-detection of connected devices, spoofing of current state of connected devices, and on-the-fly creation of policies.

In an auto-provisioning example, when a voice-over-IP (VoIP) service is enabled the protocol processor 308 is set up to track SIP, or MGCP, or both. As the VoIP phone and the gateway server run the signaling protocol, the protocol processor 308 extracts the IP-source, IP-destination, port-number, and other appropriate parameters. These are then passed to CPU 316 which sets up the policy, and enables the classifier 309, the TS cell 312, and the scheduler 314, to deliver the service.

If the bandwidth management system 300 were implemented as an application specific programmable processor (ASPP), the die size for such an IC is currently estimated at 35.72 square millimeters, at 100% utilization, using 0.18 micron CMOS technology. About one hundred and ninety-four pins would be needed on the device package. In a business model embodiment of the present invention, such an ASPP version of the bandwidth management system 300 would be implemented and marketed as hardware description language (HDL) in semiconductor intellectual property (SIA) form, e.g., Verilog code.

Broadcasts over the Internet economize on the volume and number of datapackets transmitted by relying on local routers to replicate data before the final distribution to the subscriber destinations, e.g., replicator 310 (FIG. 3). The network 100 (FIG. 1) can use any number of multicast protocols recently developed to deliver such broadcasts. The upper hierarchical levels of the network are spared having to carry duplicate datapackets, but at the lower levels real datapackets, albeit duplicates, are actually delivered to the subscriber. So the service level policy accounting and management must discern between actual traffic that consumes real bandwidth at a controlled network node and virtual multicast traffic.

IP-hosts commonly use Internet group management protocol (IGMP) to report host group memberships to neighboring multicast routers. IGMP is a required integral part of TCP/IP to be implemented by all hosts conforming to level-2 of the IP multicasting specification. IGMP messages are encapsulated in IP datagrams, with an IP protocol number of “2”. Multicast routers send host membership query messages to discover which host groups have members on their attached local networks. Queries are addressed to an all-hosts group address 224.0.0.1, with an IP time-to-live of “1”. Hosts respond to queries by generating host membership reports for each host group to which they belong on the network interface from which the query was received.

When a host receives a query, it starts a report delay timer for each of its group memberships on the network interface of the incoming query. When a timer expires, a report is generated for the corresponding host group. A report is sent with an IP-destination address equal to the host group address being reported, and with an IP time-to-live of “1”, so that other members of the same group on the same network can overhear the report. If a host hears a report for a group to which it belongs on that network, the host stops its own timer for that group and does not generate a report for that group. Thus, in the normal case, only one report will be generated for each group present on the network, by the member host whose delay timer expires first. The multicast routers receive all IP multicast datagrams, and therefore need not be addressed explicitly. Further the routers need not know which hosts belong to a group, only that at least one host belongs to a group on a particular network.

Multicast routers send queries periodically to refresh their knowledge of memberships present on a particular network. If no reports are received for a particular group after some number of queries, the routers assume that that group has no local members and that they need not forward remotely-originated multicasts for that group onto the local network. Queries are normally sent infrequently to keep the IGMP overhead on hosts and networks very low. However, when a multicast router starts up, it may issue several closely-spaced queries in order to build up its knowledge of local memberships quickly. When a host joins a new group, it transmits a report for that group in case it is the first member of that group on the network. It may be repeated once or twice after a short delay.

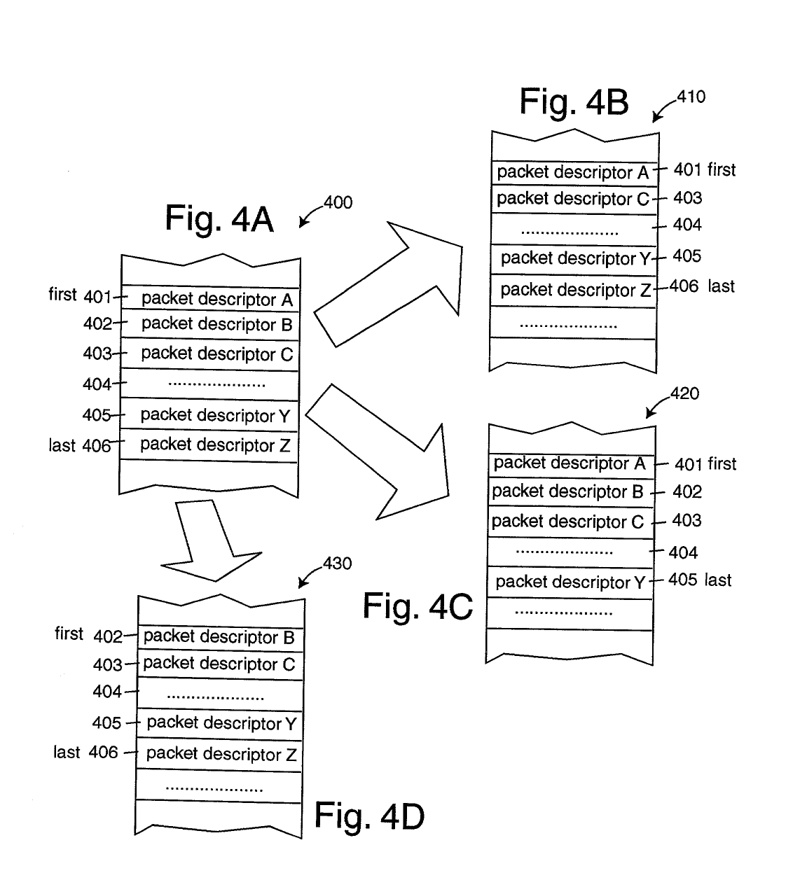

FIGS. 4A-4D illustrate the parts of queue 200 (FIG. 2) that are expanded by the replicator 310. A first multicast sub-queue 400 in FIG. 4A includes packet descriptors 401-406, e.g., in the case where the multicast expanded into six packets for delivery to six end users in network 100 (FIG. 1). Proper queue management requires that the first and last such descriptors be flagged as such, here packet descriptor-A 401 is marked as the first, and packet descriptor-Z 406 is marked as the last. In FIG. 4C, packet descriptor-Y 405 is flagged as last because the datapacket pointed to by packet descriptor-Z 406 was released to its destination. The TS cell 312 may decide to ship out any one of the associated datapackets in random order, because each may be subject to a different service level policy.

FIG. 4B shows the case where packet descriptor-B 402 has been deleted from the queue 200 because the packet is released. A sub-queue 410 comprises packet descriptors 401, and 403-406. Packet descriptor-A 401 is still first and packet descriptor-Z is still last.

But in FIG. 4C, a sub-queue 420 shows the last packet descriptor-Z 406 is missing. So its flag indicating it was last is transferred to the packet descriptor-Y 405. When all but one packet descriptor has been deleted by the TS cell 312 from the sub-queue, the remaining one will be marked both as first and last. The TS cell 312 can then delete this packet descriptor when the associated service level policy allows the corresponding datapacket to be delivered, and the actual datapacket in SRAM buffer storage can also be deleted.

FIG. 4D shows the case where packet descriptor-A 401 has been deleted from the queue 200 because the packet is released. A sub-queue 430 comprises packet descriptors 402-406. Packet descriptor-B 402 is now the first, and packet descriptor-Z is still last.

Based on the actual network architecture, the multicast datapackets are replicated at the different hierarchical levels. In the example of cable network, a multicast packet received by the regional gateway 102 will be replicated to the CMTSs 106, 108 and 110 that have end users joining the multicast group. The multicast packet received by the cable modem termination system will be replicated by the cable modem termination system to each channel 118-132 that has end users joining the multicast group. Since each channel in the cable network is shared by all end users attached to the channel, all joining end user's cable modem 146-160 can receive the multicast packet in the channel at the same time when the packet is released to the channel.

In this example, whether the received multicast packet should be replicated and sent through a channel is determined by the service-level agreement at cable modem termination system node and channel node level. The service-level agreement at regional gateway level and at the end user level is not needed for this check because the packet is already received from the gateway. When the packet is released to a channel, every end user will receive it.

The replicator 310 creates one entry for each joining end user in a cable modem termination system. It inserts the entries contiguously into the queue 200 and bounds them with the first and last flag. Each entry contains two sets of flags (xxx and yyy). Each set contains four flags that correspond to the four nodes in the entry. They are called credit checking flags and credit decrementing flags.

If the value of the credit checking flag is a one (1), the credit in the corresponding node will be checked for the sent-through decision. If the value is a zero (0), the credit in the corresponding node will not be checked.

If the value of the credit decrementing flag is a one (1), the credit in the corresponding node will be decremented when the entry is removed from the queue and the packet is sent through. If the value is a zero (0), the credit in the corresponding node will not be decremented when the entry is removed from the queue and sent through.

In the above example, assume the TS cell intellectual property is typically implemented in the cable modem termination system 106-110. When the cable modem termination system receives a multicast packet from the gateway 102, replicator 130 creates entries for each joining end user of the multicast packet and inserts them in the queue.

The replicator 310 sets zero (0) to the credit checking flags corresponding gateway node (A) and end user node (M-AA). It also sets the credit checking flags for the cable modem termination system node and the channel node to one It sets the credit decrementing flags for the gateway node to one (1) in the first entry of the entries bounded by the first and the last flag. For the rest of the entries, this flag is set to zero (0). It sets the credit decrementing flag for the cable modem termination system node to one (1) in the first entry in this sequence of entries that is the first entry corresponding to this cable modem termination system and to zero (0) in the rest of the entries. It sets the credit decrementing flag for the channel node to one (1) on only one entry corresponding to the channel and to zero (0) inn the rest of the entries. It sets the credit decrementing flag for every end user to one (1).

The TS cell processes the queue 200. It checks the SLAs of the hierarchical nodes for each queued entry according to the credit checking flags in the entry to determine whether it should be sent through or delayed in the buffer. When a packet is sent through, it decrements the credit for each node according to the credit decrementing flags in the entry.

In cable network, when a multicast packet is released to a channel, the TS cell removes all queued entries that contain the channel node in the replicated multicast entry bounded by the first and last flags.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

What is claimed is:

1. A multicast network management method, comprising the steps of:
generating a packet-tracking queue with individual entries representing datapackets for transfer through a hierarchical network;
storing an actual multicast datapacket and its real payload in a first-in, first-out (FIFO) buffer;
expanding any packet-tracking queue entry representing a multicast datapacket into several consecutive entries, one each for the individual subscribers enrolled to receive a broadcast, and wherein, each expanded entry is subject to its own unique bandwidth-allocating service-level policy;
flagging a first of such expanded entries as being first, and flagging a last such expanded entry as being last; and
releasing and clearing said datapackets in any order, and if the first or last are released, then the next or previous are marked as first or last;
wherein, individually delayed releases of duplicated multicast datapackets enforce a bandwidth limiting function of any service-level policies involved.

2. The method of claim 1, further comprising the step of:
checking to see if only a single-remaining expanded entry is left by seeing if it is flagged as being both first and last.

3. The method of claim 2, further comprising the steps of:
releasing said single-remaining expanded entry; and
clearing said packet-tracking queue and said actual datapacket and its real payload in said FIFO buffer.

4. The method of claim 1, further comprising the steps of:
associating a service-level policy that limits allowable bandwidths to particular nodes in a hierarchical network;
classifying datapackets moving through said hierarchical network according to a particular service-level policy;
managing all datapackets moving through said hierarchical network from a variable-depth queue in which each queue entry includes service-level policy bandwidth allowance for a node in said network through which a corresponding datapacket must pass;
repeatedly scanning said variable-depth queue to determine whether a datapacket should be forwarded through said node by checking for enough bandwidth-allocation credits; and
replenishing an account of said bandwidth-allocation credits taking into account a variable delay caused by scanning said variable-depth queue.

5. The method of claim 4, further comprising the step of:
testing in parallel whether a particular datapacket should be delayed in a buffer or sent along for every hierarchical node in said network through which it must pass.

6. The method of claim 4, further comprising the step of:
constructing a single queue of entries associated with corresponding datapackets passing through said hierarchical network such that each entry includes source and destination header information and a list of any available bandwidth credits for every hierarchical node in said network through which a corresponding datapacket must pass.

7. A hierarchical network for use with multicast, comprising:
means for generating a packet-tracking queue with individual entries representing datapackets for transfer through a hierarchical network;
means for storing an actual multicast datapacket and its real payload in a first-in, first-out (FIFO) buffer;
means for expanding any packet-tracking queue entry representing a multicast datapacket into several consecutive entries, one each for the individual subscribers enrolled to receive a broadcast, and wherein, each expanded entry is subject to its own unique bandwidth-allocating service-level policy;
means for flagging a first of such expanded entries as being first, and flagging a last such expanded entry as being last;
means for releasing and clearing said datapackets in any order, and if the first or last are released, then the next or previous are flagged as being first or last;
means for checking to see if only a single-remaining expanded entry is left by seeing if it is flagged as being both first and last;
means for releasing said single-remaining expanded entry; and
means for clearing said packet-tracking queue and said actual datapacket and its real payload in said FIFO buffer;
wherein, individually delayed releases of multicast datapackets enforce a bandwidth limiting function of any service-level policies involved at independent network nodes.

8. The network of claim 7, further comprising:
means for associating a service-level policy that limits allowable bandwidths to particular nodes in a hierarchical network;
means for classifying datapackets moving through said hierarchical network according to a particular service-level policy;
means for managing all datapackets moving through said hierarchical network from a variable-depth queue in which each node entry includes service-level policy bandwidth allowance for a node in said network through which a corresponding datapacket must pass;
means for repeatedly scanning said variable-depth queue to determine whether a datapacket should be forwarded through said node by checking for enough bandwidth-allocation credits; and
means for replenishing an account of said bandwidth-allocation credits taking into account a variable delay caused by scanning said variable-depth queue.

9. The means of claim 8, further comprising:
means for testing in parallel whether a particular datapacket should be delayed in a buffer or sent along for every hierarchical node in said network through which it must pass.

10. The means of claim 8, further comprising:
means for constructing a single queue of entries associated with corresponding datapackets passing through said hierarchical network such that each entry includes source and destination header information and a list of any available bandwidth credits for every hierarchical node in said network through which a corresponding datapacket must pass.

11. A network management system, comprising:
a protocol processor providing for header inspection of datapackets circulating through a network and providing for an information output comprising at least one of source IP-address, destination IP-address, port number, and application type;
a classifier connected to receive said information output and able to associate a particular datapacket with a particular network node and a corresponding service-level policy bandwidth allowance;
a variable-depth queue comprising individual entries related to said datapackets circulating through said network, and further related to a network node through which each must pass;
a replicator for duplicating datapackets in a multicast stream for each enrolled subscriber, and able to expand the variable-depth queue with expanded multicast entries; and
a traffic-shaping cell providing for an inspection of each one of said individual entries and for outputting a single decision whether to pass through or buffer each of said datapackets in all network nodes through which each must pass;
wherein, individually delayed releases of multicast datapackets enforce a bandwidth limiting function of any service-level policies involved.

12. The system of claim 11, further comprising:
an output scheduler and marker for scheduling a released datapacket for output, and for marking it according to an output received from the traffic-shaping cell.

13. The system of claim 11, further comprising:
at least one of the protocol processor, classifier, replicator, and traffic-shaping cell, are implemented as a semiconductor intellectual property and operate at run-time with the variable-depth queue.
